(19) United States
(12) Patent Application Publication
(10) Pub. No.: US 2012/0331265 A1
(43) Pub. Date: Dec. 27, 2012

(54) Apparatus and Method for Accelerated Hardware Page Table Walk

(75) Inventors: Ranjit Joseph Rozario, San Jose, CA (US); Sanjay Patel, San Ramon, CA (US)

(73) Assignee: MIPS TECHNOLOGIES, INC., Sunnyvale, CA (US)

(21) Appl. No.: 13/168,870

(22) Filed: Jun. 24, 2011

(51) Int. Cl. G06F 12/10

(52) U.S. Cl. 711/207; 711/E12.059

(57) ABSTRACT

A method of walking page tables includes comparing a virtual address to a plurality of virtual address bit segments to identify a match. Each virtual address bit segment is associated with a page table level that has a page table base address. A designated page table base address is received in response to the match. The page table walk starts at the designated page table, thereby skipping over earlier page tables.

### FIELD OF THE INVENTION

This invention relates generally to accessing computer memory. More particularly, this invention relates to accelerating a hardware page table walk.

### BACKGROUND OF THE INVENTION

Virtual memory virtualizes a computer architecture's various hardware memory devices (e.g., Random Access Memory (RAM) and disk storage drives) so that a computer program can be designed as if there is only one hardware memory device. The program has sole access to this virtual resource as a contiguous working memory. Virtual memory uses hardware memory more efficiently than systems without virtual memory. Consequently, a virtual memory system makes programming applications easier by hiding fragmentation, delegating to the kernel the burden of managing the memory hierarchy and obviating the need to relocate program code.

A page table is a data structure used by a virtual memory system in a computer operating system to store the mapping between virtual addresses and physical addresses. Physical addresses are unique to the hardware (i.e., RAM). Virtual addresses are unique to an accessing program.

In operating systems that use virtual memory, every process is given the impression that it is working with large, contiguous sections of memory. In reality, each process' memory may be dispersed across different areas of physical memory, or may have been paged out to backup storage (e.g., a disk storage drive). When a process requests access to its memory, it is the responsibility of the operating system to map the virtual address provided by the process to the physical address where that memory is stored. The page table is where the operating system stores its mappings of virtual addresses to physical addresses.

FIG. 1 illustrates a prior art technique for processing a virtual address 100. The virtual address 100 includes a virtual page number 102 and a page offset 104. The page offset 104 operates as an index value into a specified virtual page.

A virtual address is initially applied to a translation look-aside buffer 106. The translation look-aside buffer 106 stores a virtual page number and a corresponding physical page number. If the virtual address 100 finds a matched virtual address in the TLB 106, a hit occurs and a physical address 108 is supplied. The physical address 108 may now be combined with the page offset 104 to access a specified physical memory location.

If a virtual address is not matched by the TLB 106, a miss occurs and a page table walk mechanism 110 is invoked. The page table walk mechanism 110 may be a software or hardware resource. The page table walk mechanism 110 maintains a base address for a root page table 112_1. The base address for the root page table 112_1 is accessed and segments of the virtual page number are used to index into a location 114 in the root page table 112_1. If the location 114 contains a physical address, then the physical address is returned to the page table walk mechanism 110. If the location 114 does not contain a physical address, it specifies the base address for the next page table. In this case, the page table walk mechanism 110 continues its walk to the next page table 112_2. Different segments of the virtual page number are then used to index into a location 116 in the first level page table 112_2. If location 116 contains a physical address, the physical address is returned to the page table walk mechanism 110. Otherwise, the location contains the base address for another level of the page tables. This process is repeated, if necessary, up to a final page table 112_N. Different segments of the virtual page number are used to access a location 118 in the final page table 112_N. The final page table 112_N supplies a physical address to the page table walk mechanism 110. If the location 118 in the final page table 112_N does not contain a physical address, then an error handling process is invoked.

It can appreciated that this page table walk process can be relatively time consuming. Therefore, it would be desirable to provide a technique for accelerating a page table walk.

### SUMMARY OF THE INVENTION

A method of walking page tables includes comparing a virtual address to a plurality of virtual address bit segments to identify a match. Each virtual address bit segment is associated with a page table level that has a page table base address. A designated page table base address is received in response to the match. The page table walk starts at the designated page table, thereby skipping over earlier page tables.

A non-transitory computer readable storage medium includes instructions to define a memory storing virtual address bit set segments and corresponding page table base addresses. A page table walk mechanism applies a virtual address to the memory and processes a memory output signal.

A processor includes a content addressable memory storing virtual address bit set segments and corresponding page table base addresses. A page table walk mechanism applies a virtual address to the content addressable memory and processes a content addressable memory output signal.

A non-transitory computer readable storage medium includes executable instructions to form page tables, identify virtual address bit segments required to reach a plurality of page table levels, and associate the virtual address bit segments with corresponding page table base addresses for the plurality of page table levels.

A system comprises a processor with an associated page table walk mechanism and page table walk mechanism memory. A memory stores an operating system with executable instructions executed by the processor to form page tables, identify virtual address bit segments required to reach a plurality of page table levels, associate the virtual address bit segments with corresponding page table base addresses for the plurality of page table levels, and load the virtual address bit segments with corresponding page table base addresses into the page table walk mechanism memory. The page table walk mechanism applies a virtual address to the page table walk mechanism memory and processes an output signal therefrom.

### BRIEF DESCRIPTION OF THE FIGURES

The invention is more fully appreciated in connection with the following detailed description taken in conjunction with the accompanying drawings, in which:

FIG. 1 illustrates a prior art page table walk technique.

FIG. 2 illustrates a page table walk mechanism utilized in accordance with an embodiment of the invention.

FIG. 3 illustrates a memory loading process utilized in accordance with an embodiment of the invention.

FIG. 4 illustrates a memory configured in accordance with an embodiment of the invention.

FIG. 5 illustrates a page table walk process utilized in accordance with an embodiment of the invention.

FIG. 6 illustrates a system configured in accordance with an embodiment of the invention.

Like reference numerals refer to corresponding parts throughout the several views of the drawings.

### DETAILED DESCRIPTION OF THE INVENTION

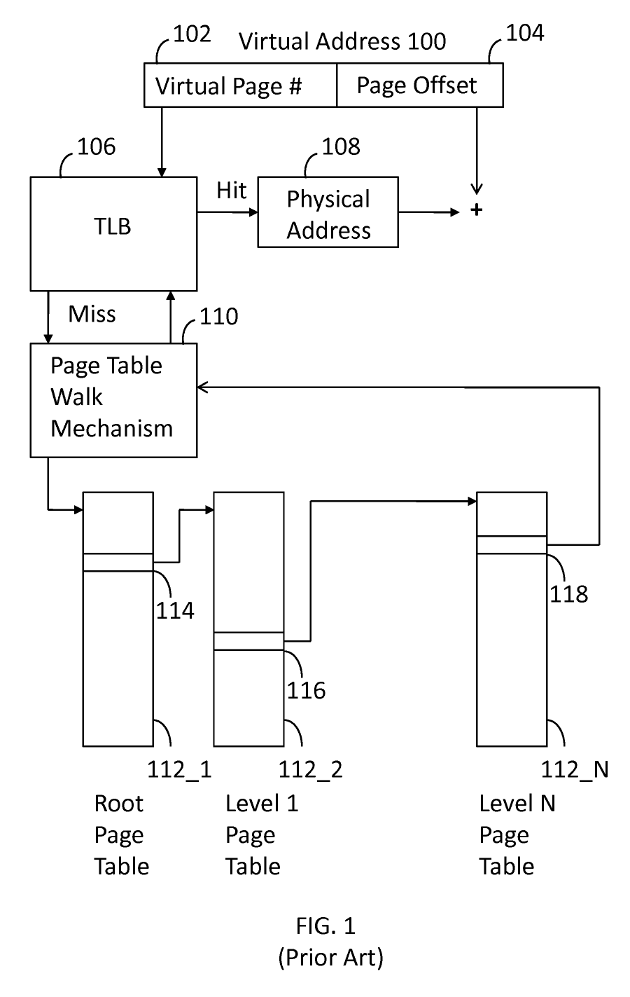

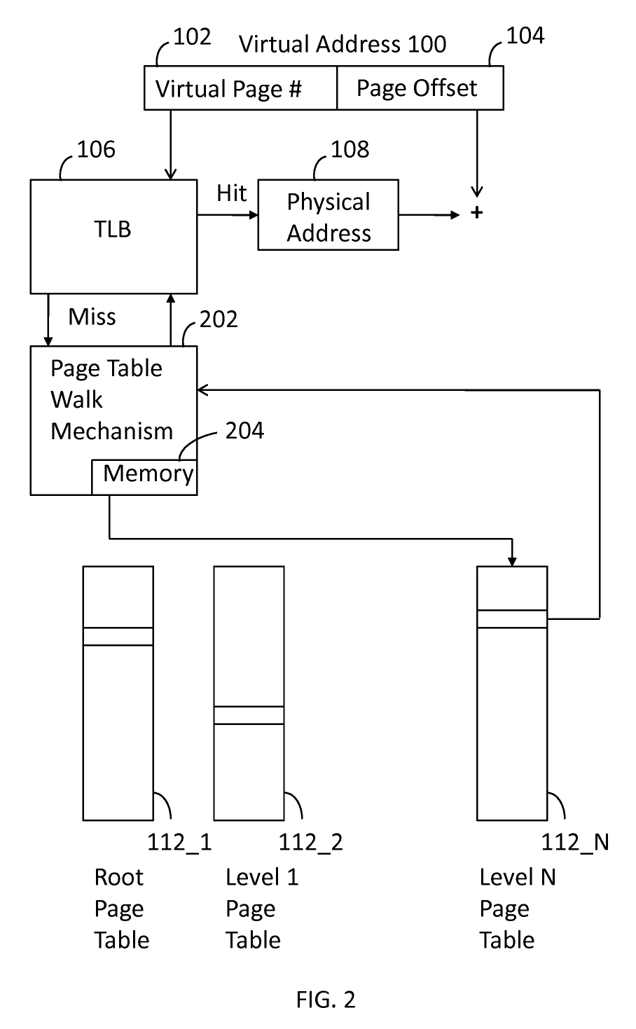

FIG. 2 illustrates a page table walk mechanism utilized in accordance with an embodiment of the invention. Elements 100 through 106 operate in accordance with the description supplied in connection with FIG. 1.

The page table walk mechanism 202 is configured in accordance with an embodiment of the invention. Preferably, the page table walk mechanism is implemented in hardware and includes a dedicated memory 204. The memory 204 stores virtual address bit segments and corresponding page table base addresses. Each virtual address bit segment is associated with a page table level that has a page table base address.

The page table walk mechanism 202 compares a virtual address received from the TLB 106 to the virtual address bit segments to identify a match. The page table walk mechanism receives a designated page table base address in response to a match. Thereafter, the page table walk mechanism 202 skips to the designated page table base address. Thus, for example, the page table walk mechanism 202 may skip to level N page table 112_N. Consequently, the processing delay associated with walking through each previous page table, as in the case of the prior art system of FIG. 1, is avoided. The physical address from the level N page table 112_N is supplied to the page table walk mechanism 202, which routes it to the TLB 106 for subsequent processing in a standard manner.

Thus, those skilled in the art will appreciate that the page table walk mechanism 202 provides an accelerated hardware page table walk. This accelerated hardware page table walk is achieved by avoiding intermediate stepping through page tables prior to reaching a target table.

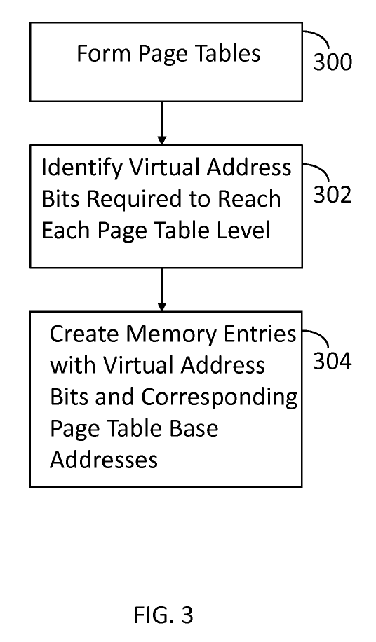

The invention may be implemented in any number of ways. FIG. 3 illustrates processing operations associated with one embodiment of the invention. The processing of FIG. 3 may be implemented by an operating system. Initially, page tables are formed 300. Thereafter, virtual address bits required to reach each page table level are identified 302. Memory entries are then created with virtual address bits and corresponding page table base addresses 304.

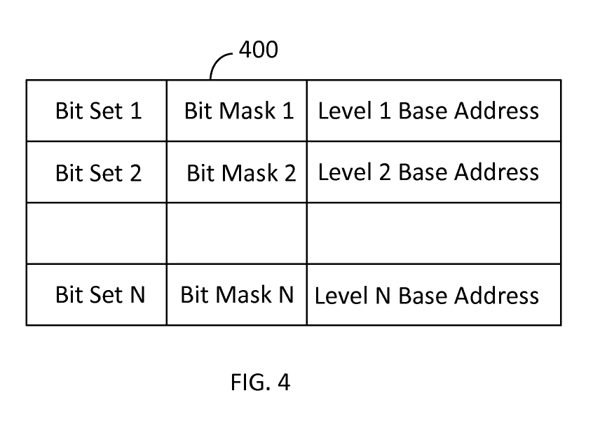

FIG. 4 illustrates an exemplary memory 400. The first row of the memory has a first bit set (e.g., a segment of the virtual page number), a bit mask (e.g., specifying bits to ignore) and a corresponding level 1 base address. The next row of the memory has a second bit set, second bit mask and a corresponding level 2 base address. This configuration is repeated for N bit sets and N corresponding level base addresses.

The foregoing operations are more fully appreciated in connection with a specific example. Consider a 64 bit system. Forty-eight bits may be designated for virtual addresses. If 4 KB page sizes are used, this results in four levels of page tables. In this case, bits 47-39 may be associated with one level, bits 38-30 may be associated with another level, bits 29-21 may be associated with another level and bits 20-12 may be associated with another level. The operating system knows the base address for each level and therefore can associate each level with the appropriate page table base address.

The memory 400 may be implemented as a ternary content addressable memory (CAM). A CAM is a computer memory configured for very high speed searching applications. Unlike a standard computer memory (e.g., Random Access Memory or RAM) in which the user supplies a memory address and the RAM returns data for the specified address, a CAM is designed such that an input value is compared to the entire memory. Upon a match, an output value is supplied, in this case, a page table base address. A ternary CAM allows three states: zero, one and don't care. For example, a ternary CAM might have a stored word of “10XX0”, which will match any of the four inputs “10000”, “10010”, “10100” or “10110”. It can be appreciated that this feature can be used to compare an input virtual address to different virtual address bit sets in memory 400. The page table walk mechanism processes the output hit signal at the deepest level of the page table walk structure. This page table base address is used to circumvent the earlier stages of the page table walk.

Advantageously, a very small CAM may be used in accordance with an embodiment of the invention. For example, the CAM may be loaded with only two or three entries for frequently accessed locations (e.g., stack address, instruction location, shared library). In this instance, a very small CAM results in a large processing improvement.

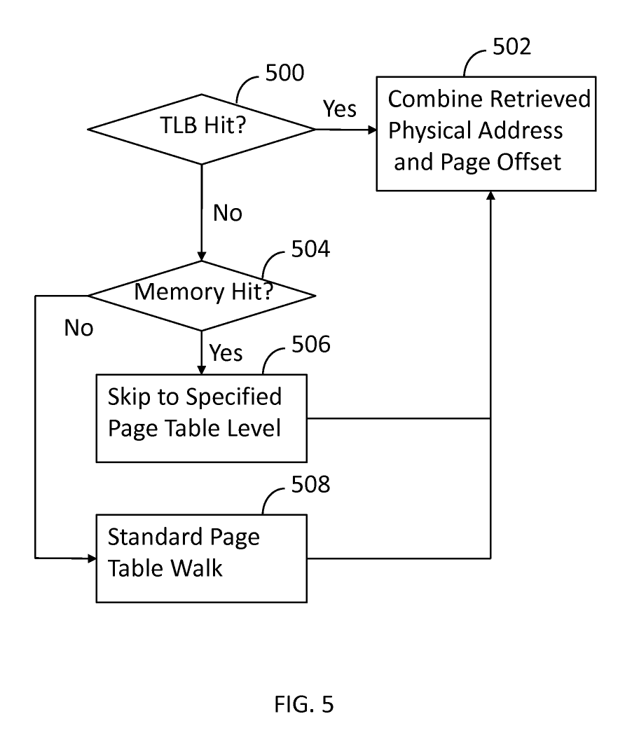

FIG. 5 illustrates processing operations associated with a system configured in accordance with an embodiment of the invention. A virtual address is initially applied to the TLB 106. If there is a hit (500-YES), then the physical address from the TLB is combined with the page offset of the virtual address 502. If there is a TLB miss (500-NO), then the page table walk mechanism 202 searches memory 204. If there is a memory hit (504-YES), the page table walk mechanism skips to the specified page table level 506 and processing proceeds to block 502. If there is a memory miss (504-NO), then the page table walk mechanism 202 invokes standard page table walk operations 508.

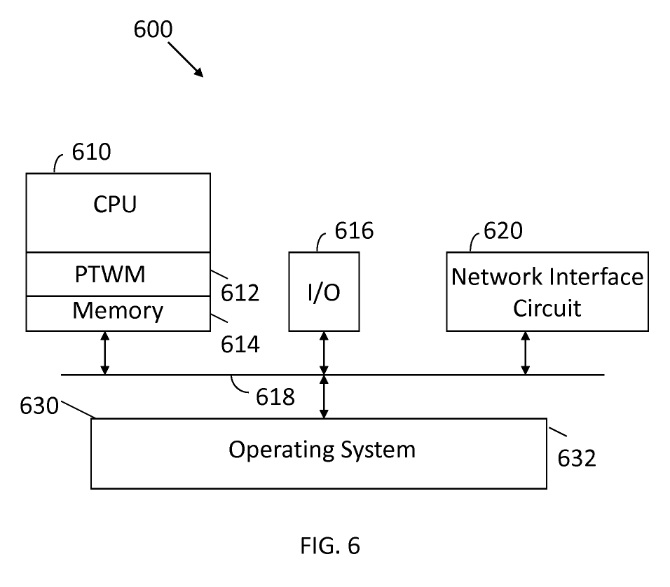

FIG. 6 illustrates a system 600 configured in accordance with an embodiment of the invention. The system 600 includes a processor 610, which includes, or has an associated, page table walk mechanism 612 and page table walk mechanism memory 614.

The system 100 also includes input/output devices 616 connected to the processor 610 via a bus 618. The input/output devices 616 may include a keyboard, mouse, display and the like. A network interface circuit 620 is also connected to the bus 618 to provide connectivity to a network. A memory 630 is also connected to the bus 618. The memory 630 stores an operating system 632 configured to incorporate operations of the invention. In particular, the operating system 632, or a program operating in conjunction with the operating system 632, forms page tables. The virtual address bit segments required to reach a plurality of page table levels are identified. Each virtual address bit segment is associated with a page table base address for a page table level. The virtual address bit segments with corresponding page table base addresses are then loaded into the page table walk mechanism memory. Thereafter, the page table walk mechanism may be operated in the disclosed manner to circumvent early page table levels, if applicable, and thereby accelerate memory access operations.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a non-transitory computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). It is understood that a CPU, processor core, microcontroller, or other suitable electronic hardware element may be employed to enable functionality specified in software.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A method of walking page tables, comprising:
comparing a virtual address to a plurality of virtual address bit segments to identify a match, wherein each virtual address bit segment is associated with a page table level that has a page table base address;
receiving a designated page table base address in response to the match; and
skipping to the designated page table base address.

2. The method of claim 1 proceeded by:
forming page tables;
identifying the plurality of virtual address bit segments; and
associating each virtual address bit segment with a page table base address for a page table level.

3. A non-transitory computer readable storage medium, comprising instructions to define:
a memory storing virtual address bit set segments and corresponding page table base addresses; and
a page table walk mechanism to apply a virtual address to the memory and process a memory output signal.

4. The non-transitory computer readable storage medium of claim 3 wherein the page table walk mechanism is configured to process a memory output hit signal with a corresponding page table base address and invoke the corresponding page table base address.

5. The non-transitory computer readable storage medium of claim 3 wherein the page table walk mechanism is configured to process a memory output miss signal and invoke a standard page table walk operation.

6. A processor, comprising:
a content addressable memory storing virtual address bit set segments and corresponding page table base addresses; and
a page table walk mechanism to apply a virtual address to the content addressable memory and process a content addressable memory output signal.

7. The processor of claim 6 wherein the page table walk mechanism processes a content addressable memory output hit signal with a corresponding page table base address and invokes the corresponding page table base address.

8. The processor of claim 6 wherein the page table walk mechanism processes a content addressable memory output miss signal and invokes a standard page table walk operation.

9. A non-transitory computer readable storage medium, comprising executable instructions to:
form page tables;
identify virtual address bit segments required to reach a plurality of page table levels; and
associate the virtual address bit segments with corresponding page table base addresses for the plurality of page table levels.

10. The non-transitory computer readable storage medium of claim 9 further comprising executable instructions to load the virtual address bit segments and corresponding page table base addresses into a memory.

11. The non-transitory computer readable storage medium of claim 10 further comprising executable instructions to load the virtual address bit segments and corresponding page table base addresses into a content addressable memory.

12. The non-transitory computer readable storage medium of claim 11 further comprising executable instructions to load the virtual address bit segments and corresponding page table base addresses into a ternary content addressable memory.

13. A system comprising:
a processor with an associated page table walk mechanism and page table walk mechanism memory;
a memory storing an operating system with executable instructions executed by the processor to:
form page tables,
identify virtual address bit segments required to reach a plurality of page table levels,
associate the virtual address bit segments with corresponding page table base addresses for the plurality of page table levels, and
load the virtual address bit segments with corresponding page table base addresses into the page table walk mechanism memory;
wherein the page table walk mechanism applies a virtual address to the page table walk mechanism memory and processes an output signal therefrom.

14. The system of claim 13 wherein the page table walk mechanism processes an output hit signal with a corresponding page table base address and invokes the corresponding page table base address.

15. The system of claim 13 wherein the page table walk mechanism processes an output miss signal and invokes a standard page table walk operation.
